(19) United States
(12) Patent Application Publication
(10) Pub. No.: US 2018/0061280 A1
(43) Pub. Date: Mar. 1, 2018

(54) THREE-DIMENSIONAL OBJECT

(71) Applicant: MIMAKI ENGINEERING CO., LTD., Nagano (JP)

(72) Inventors: Eiji MIYASHITA, Nagano (JP); Yoshihiro TANAKA, Nagano (JP); Kunio HAKKAKU, Nagano (JP)

(21) Appl. No.: 15/688,092

(22) Filed: Aug. 28, 2017

(30) Foreign Application Priority Data
Aug. 31, 2016 (JP) 2016-169348

(51) Int. Cl. G09B 23/36

(52) U.S. Cl. CPC G09B 23/36; B33Y 80/00

(57) ABSTRACT

The three-dimensional object has a plurality of parts and a joining member that joins these parts. The joining member is independent from the parts. At the time of separating the parts from each other, the joining member is broken by pulling with a certain or greater strength one of the parts from the other in a direction in which one of the part is drawn apart from the other, or by rotating with a certain or greater strength one of the parts relative to the other about the part's center axis.

### CROSS REFERENCE TO RELATED APPLICATIONS

This application claims the priority benefit of Japanese Patent Application No. 2016-169348, filed on Aug. 31, 2016. The entirety of the above-mentioned patent application is hereby incorporated by reference herein and made a part of this specification.

### TECHNICAL FIELD

This disclosure relates to a three-dimensional object.

### DESCRIPTION OF THE BACKGROUND ART

A known example of three-dimensional objects is a life-sized bust (for instance, Japanese Unexamined Patent Publication No. 2003-196486).

### SUMMARY

Three-dimensional objects large in size, such as life-sized models or even larger models of persons, may be too heavy to carry or handle with ease during transportation and installation.

This disclosure is directed to providing a three-dimensional object easier to handle than the known art even if the object is large in size.

This disclosure provides a three-dimensional object including a plurality of parts and a joining member that joins the plurality of parts characterized in that the joining member is independent from the plurality of parts and is breakable at the time of separating the plurality of parts that are joined.

The three-dimensional object disclosed herein can be divided into smaller parts and thus may be easier to handle than the known art during transportation and installation even if the object is large in size. The joining member joining the parts of this three-dimensional object may need to be broken to detach the joined parts from each other. in that case, reuse of the joining member is not possible. On the other hand, the joined parts may be easily separated by simply breaking the joining member.

This disclosure further provides a three-dimensional object including a plurality of parts and a joining member that joins the plurality of parts characterized in that the plurality of parts include bindable sections to be tied together with the joining member, and the joining member is independent from the plurality of parts and serves to bind the bindable sections of the plurality of parts to join these parts.

The three-dimensional object thus characterized can be divided into smaller parts and thus may be easier to handle than the known art during transportation and installation even if the object is large in size. This three-dimensional object is structured to join the plurality of parts by having the bindable sections tied together with the joining member. This may facilitate the process to join the parts.

In the three-dimensional object disclosed herein, one and another one of the plurality of parts joined with the joining member may include mating sections to be mated with each other in a direction in which the plurality of parts are joined with the joining member.

In the three-dimensional object thus characterized, the mating sections of two parts are mated with each other. This structural feature may prevent displacement of the two parts in a direction orthogonal to a direction in which these two parts are joined with the joining member. Thus, the parts may be more reliably joined.

This disclosure further provides a three-dimensional object including a plurality of parts, a joining member that joins the plurality of parts, and a reinforcing member that reinforces joints of the plurality of parts characterized in that the reinforcing member is independent from the plurality of parts and is containable inside of the plurality of parts.

The three-dimensional object thus characterized can be divided into smaller parts and thus may be easier to handle than the known art during transportation and installation even if the object is large in size. In the three-dimensional object further provided with the reinforcing member that reinforces the joints of the parts, breakage of the parts at their joints may be unlikely to occur.

In the three-dimensional object, the reinforcing member may constitute at least part of the joining member.

By thus having the reinforcing member constitute at least part of the joining member, the three-dimensional object may be structurally simplified.

This disclosure further provides a three-dimensional object including a plurality of parts characterized in that the plurality of parts include a plurality of insertion parts that include inserts to be inserted, and the plurality of parts further include insert-receiving parts having a plurality of receiving sections that receive the inserts to be inserted. The insert of at least one of the plurality of insertion parts includes a receiving section. With the inserts of the plurality of insertion parts being inserted in corresponding ones of the receivers of the insert-receiving parts, the receiving section receives the insert to be inserted of at least another one of the plurality of insertion parts.

The three-dimensional object thus characterized can be divided into smaller parts and thus may be easier to handle than the known art during transportation and. installation even if the object is large in size. In this three-dimensional object, the insertion parts engaged with each other may be immovably secured. Therefore, a part-joining member independent from the respective parts is less required of such a three-dimensional object. This may facilitate the process to separate the parts.

The three-dimensional object disclosed herein may be easier to handle than the known art even if the object is large in size.

### BRIEF DESCRIPTION OF THE DRAWINGS

FIG. 1 is an external perspective view of a three-dimensional object according to a first embodiment of the present disclosure.

FIG. 2 is a front, cross-sectional view of the three-dimensional object illustrated in FIG. 1.

FIG. 3 is an exploded front, cross-sectional view of the three-dimensional object illustrated in FIG. 1.

FIG. 4 is a front view of a 3D printer used to manufacture at least part of the three-dimensional object illustrated in FIG. 1.

FIG. 5 is a block diagram of the 3D printer illustrated in FIG. 4.

FIG. 6A is a front, cross-sectional view of an example of parts of the three-dimensional object illustrated in FIG. 1. FIG. 6B is a front, cross-sectional view of an example of parts of the three-dimensional object illustrated in FIG. 1 that differs from the example of FIG. 6A. FIG. 6C is a front, cross-sectional view of an example of parts of the three-dimensional object illustrated in FIG. I that differs from the examples of FIGS. 6A and 6B.

FIG. 7 is a drawing of the part illustrated in FIG. 6C during a manufacturing process.

FIG. 8 is a front, cross-sectional view of an example of parts of the three-dimensional object illustrated in FIG. 1 that differs from the examples of FIGS. 6.

FIG. 9A is a bottom view of an example of parts of the three-dimensional object illustrated in FIG. 1 that differs from the examples of FIGS. 6 and 8. FIG. 9B is an I-I cross-sectional view of FIG. 9A.

FIG. 10 is a perspective view of an example of parts of the three-dimensional object illustrated in FIG. 1 that differs from the examples of FIGS. 6, 8, and 9.

FIG. 11 is a perspective view in part of a three-dimensional object according to a second embodiment of the present disclosure.

FIG. 12 is an exploded perspective view in part of the three-dimensional object illustrated in FIG. 11.

FIG. 13 is an exploded perspective view in part of the three-dimensional object that differs from the example of FIG. 12.

FIG. 14 is a front, cross-sectional view in part of a three-dimensional object according to a third embodiment of the present disclosure.

FIG. 15 is an exploded front, cross-sectional view in part of the three-dimensional object illustrated in FIG. 14.

FIG. 16 is a front, cross-sectional view of the three-dimensional object that differs from the example of FIG. 14.

FIG. 17 is an exploded side view of a three-dimensional object according to a fourth embodiment of the present disclosure.

FIG. 18 is an exploded plan view of the three-dimensional object illustrated in FIG. 17.

FIG. 19 is an exploded perspective view of the three-dimensional object illustrated in FIG. 17 when observed from the bottom side of the object.

### DETAILED DESCRIPTION OF EMBODIMENTS

Hereinafter, embodiments of this disclosure are described referring to the accompanying drawings.

### First Embodiment

First, the structure of a three-dimensional object according to a first embodiment of the present disclosure is hereinafter described.

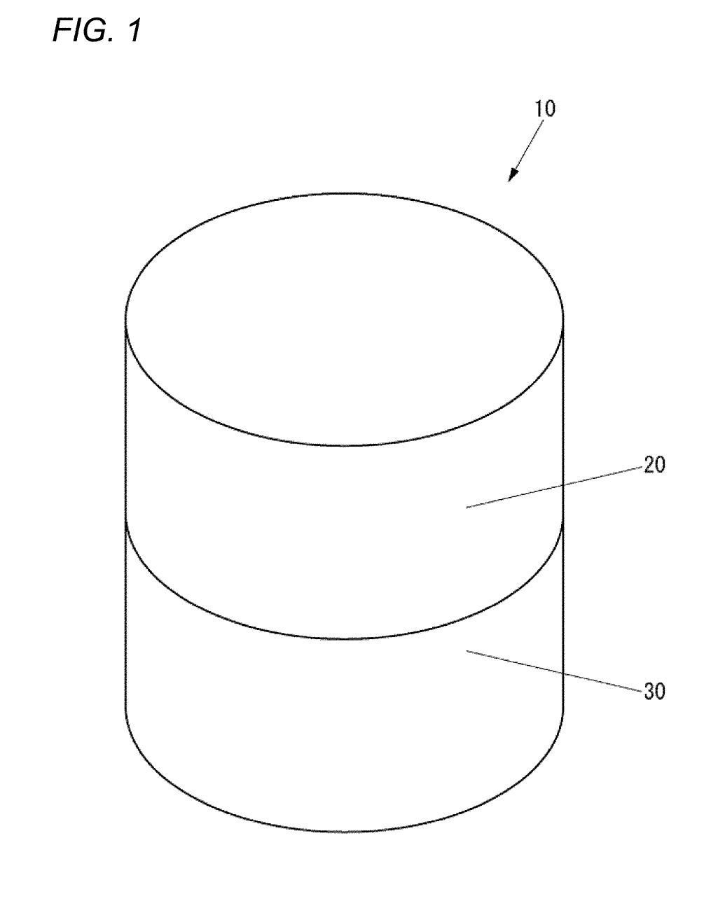

FIG. 1 is an external perspective view of a three-dimensional object 10 according to this embodiment.

As illustrated in FIG. 1, the three-dimensional object 10 is a columnar object.

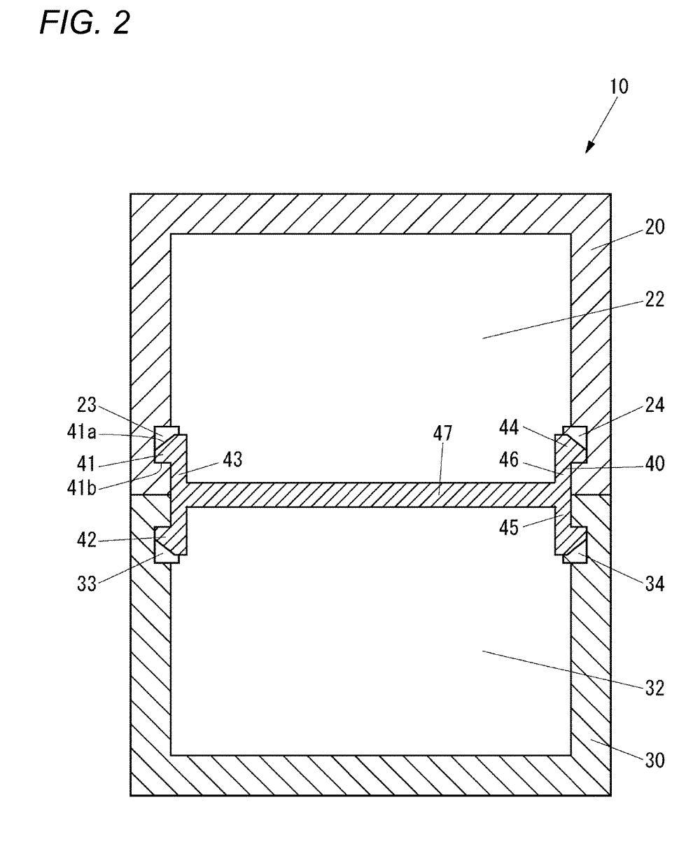

FIG. 2 is a front, cross-sectional view of the three-dimensional object 10.

As illustrated in FIGS. 1 and 2, the three-dimensional object 10 includes a part 20, a part 30, and a joining member 40 that joins the parts 20 and 30. The joining member 40 is independent from the parts 20 and 30.

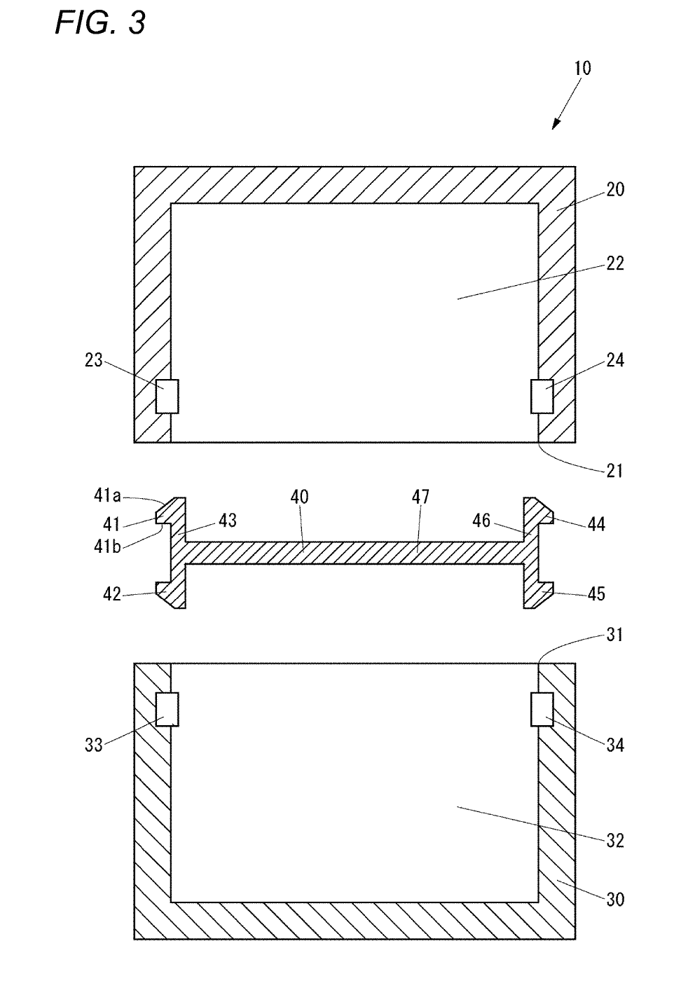

FIG. 3 is an exploded front, cross-sectional view of the three-dimensional object 10.

As illustrated in FIGS. 1 to 3, the part 20 has a columnar shape and has a circular opening 21 on one of two bottom-surface sides of the columnar shape. There is a columnar space 22 inside the part 20 having the opening 21 on one of two bottom-surface sides. The part 20 has grooves 23 and 24 on its inner side facing the space 22. The joining member 40 is fitted in these grooves.

The part 30 has a columnar shape and has a circular opening 31 on one of two bottom-surface sides of the columnar shape. There is a columnar space 32 inside the part 30 having the opening 31 on one of two bottom-surface sides. The part 30 has grooves 33 and 34 on its inner side facing the space 32. The joining member 40 is fitted in these grooves.

The joining member 40 has a claw 41 to be fitted in the groove 23, a claw 42 to be fitted in the groove 33, a connector 43 that interconnects the claws 41 and 42, a claw 44 to be fitted in the groove 24, a claw 45 to be fitted in the groove 34, a connector 46 that interconnects the claws 44 and 45, and a connector 47 that interconnects the connectors 43 and 46. The joining member 40 is inferior in strength to the parts 20 and 30. The joining member 40 is broken at the time of separating the joined parts 20 and 30, which will be described later.

The claw 41 has an inclined surface 41a and an anti-separation surface 41b . When the joining member 40 is attached to the part 20, the inclined surface 41a contacts the wall of the part 20 to deform the connector 43, and the anti-separation surface 41b contacts the wall of the part 20 where the groove 23 is formed to prevent the joining member 40 from being detached from the part 20. This structural feature of the claw 41 goes for the claws 42, 44, and 45 as well.

A method for manufacturing the three-dimensional object 10 is hereinafter described.

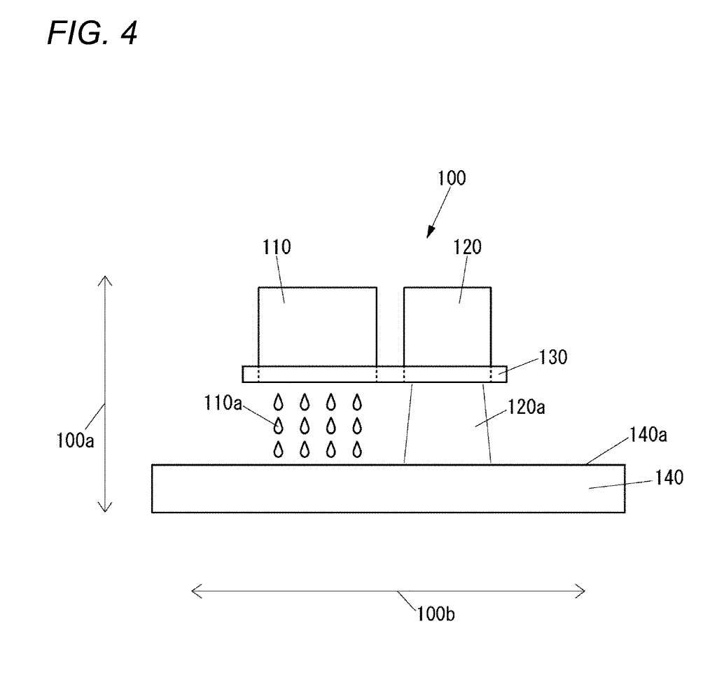

FIG. 4 is a front view of a 3D printer 100 used to manufacture at least part of the three-dimensional object 10.

On the lower side in a vertical direction indicated with arrow 100a, the 3D printer 100 has a carriage 130 mounted with a plurality of ink jet heads 110 and an ultraviolet irradiator 120, as illustrated in FIG. 4. The ink jet heads 110 discharge an ultraviolet-curing type ink (hereinafter, UV ink) 110a. The ultraviolet irradiator 120 irradiates the UV ink 110a discharged from the ink jet heads 110 with ultraviolet light 120a.

While one ink jet head 110 is illustrated in FIG. 4, the 3D printer 100 may be equipped with plural ink jet heads 110 from which the UV inks 110a of different types are discharged.

Examples of the UV ink 110a may include a molding ink and a support ink. The molding ink is the material of a 3D object. The support ink is the material of a support portion. To obtain an optionally-shaped 3D object, the support portion supports the object currently formed of the molding ink. Examples of the molding ink may include color inks for surface portions of the 3D object, and a white ink for the object's interior that enhances color development of the color inks. Examples of the support ink may include inks easily removable by particular liquid, such as water. The support portion is formed by the 3D printer 100 horizontally and/or on the vertically lower side of the 3D object. In case the 3D object has an overhang portion, for example, the support portion is formed on the vertically lower side of the overhang portion to support the overhang portion.

The 3D printer 100 has a table 140 with a support surface 140a. The support surface 140a supports the support portion and the 3D object formed with the UV ink 110a discharged from the ink jet head 110 and cured by ultraviolet light 120a radiated from the ultraviolet irradiator 120.

The support surface 140a extends in a horizontal direction indicated with arrow 100b.

One of the carriage 130 and the table 140 is allowed to horizontally move relative to the other.

For example, the carriage 130 is supported by a mechanism, not illustrated in the drawings, so as to move in a main scanning direction included in horizontal directions. The carriage 130 thus supported is allowed to move relative to the table 140 in the main scanning direction. In the description below, the carriage 130 moves in the main scanning direction so as to move relative to the table 140 in the main scanning direction. Optionally, the table 140 may be moved in the main scanning direction so as to move relative to the carriage 130 in the main scanning direction, or the carriage 130 and the table 140 may both be allowed to move in the main scanning direction, so that one of the carriage 130 and the table 140 moves relative to the other in the main scanning direction.

For example, the carriage 130 is supported by a mechanism, not illustrated in the drawings, so as to move in a sub scanning direction orthogonal to the main scanning direction included in horizontal directions. The carriage 130 thus supported is allowed to move relative to the table 140 in the sub scanning direction. In the description below, the carriage 130 moves in the sub scanning direction so as to move relative to the table 140 in the sub scanning direction. Optionally, the table 140 may be moved in the sub scanning direction so as to move relative to the carriage 130 in the sub scanning direction, or the carriage 130 and the table 140 may both be allowed to move in the sub scanning direction, so that one of the carriage 130 and the table 140 moves relative to the other in the sub scanning direction.

One of the carriage 130 and the table 140 is allowed to vertically move relative to the other. The table 140 is supported by a mechanism, not illustrated in the drawings, so as to move in the vertical direction. The table 140 thus supported is allowed to move relative to the carriage 130 in the vertical direction. In the description below, the table 140 moves in the vertical direction so as to move relative to the carriage 130 in the vertical direction. Optionally, the carriage 130 may be moved in the vertical direction so as to move relative to the table 140 in the vertical direction, or the carriage 130 and the table 140 may both be allowed to move in the vertical direction, so that one of the carriage 130 and the table 140 moves relative to the other in the vertical direction.

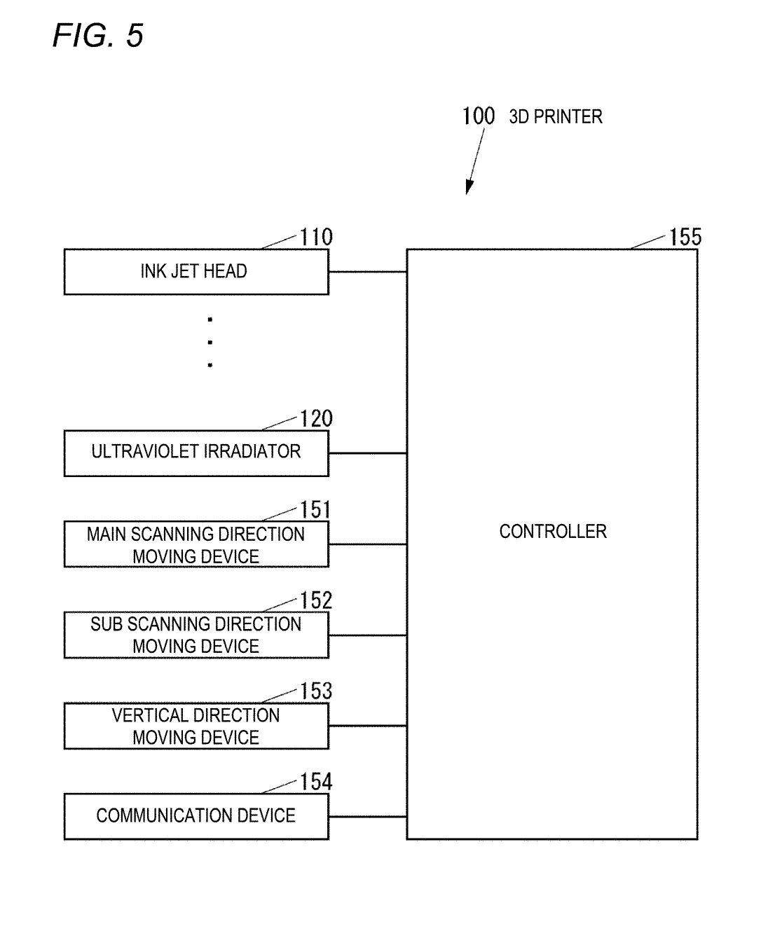

FIG. 5 is a block diagram of the 3D printer 100.

As illustrated in FIG. 5, the 3D printer 100 has a main scanning direction moving device 151, a sub scanning direction moving device 152, a vertical direction moving device 153, a communication device 154, and a controller 155. The main scanning direction moving device 151 moves the carriage 130 in the main scanning direction. The sub scanning direction moving device 152 moves the carriage 130 in the sub scanning direction. The vertical direction moving device 153 moves the table 140 in the vertical direction. The communication device 154 communicates with (an) external device(s) through a network such as LAN (Local Area Network) or directly communicates with an external device(s) wirelessly or by cable without the intervention of such a network. The controller 155 controls functions of the whole 31) printer 100.

The controller 155 has, for example, a CPU (Central Processing Unit), ROM (Read Only Memory) in which programs and various data are prestored, and RAM (Random Access Memory) used as the CPU's work area. The CPU is configured to run the programs prestored in the ROM.

Based on 3D data inputted through the communication device 154, the controller 155 controls the ink jet head 110, ultraviolet irradiator 120, main scanning direction moving device 151, sub scanning direction moving device 152, and vertical direction moving device 153. Specifically, the controller 155 prompts the sub scanning direction moving device 152 to change the position of the carriage 130 relative to the table 140 in the sub scanning direction. In response to every position change of the carriage 130, the controller 155, while prompting the main scanning direction moving device 151 to move the carriage 130 in the main scanning direction, prompts the ink jet head 110 and the ultraviolet irradiator 120 to form horizontally extending layers using the molding and support inks. The controller 155 prompts the vertical direction moving device 153 to change the position of the table 140 relative to the carriage 130 in the vertical direction, in response to every position change of the table 140, the controller 155 repeatedly prompts the ink jet head 110 and the ultraviolet irradiator 120 to operate as described earlier. As a result, horizontally extending layers formed with the molding and support inks are vertically stacked on one another to form a 3D object and a support portion on the table 140.

In a case where a support portion-attached 3D object is formed, an operator removes the support portion from the 3D object to obtain a final 3D product.

An operator forms the parts 20 and 30 and the joining member 40 by 3D printing using the 3D printer 100, and then joins the parts 20 and 30 with the joining member 40 to obtain a 3D object.

Specifically, when the claws 41 and 44 of the joining member 40 are pushed into the space 22 through the opening 21 of the part 20, the inclined surface 41a of the claw 41 and the inclined surface of the claw 44 contact the wall of the part 20. Subsequently, the connectors 43 and 46 are deformed in a manner that the claws 41 and 44 are brought closer to each other, and the claws 41 and 44 further progress into the space 22. When the claws 41 and 44 progressing into the space 22 finally arrive at positions of the grooves 23 and 24, the connectors 43 and 46 are deformed by their restoring forces in a manner that the claws 41 and 44 are drawn apart from each other. Then, the claws 41 and 44 are respectively fitted in the grooves 23 and 24. When the claws 41 and 44 are respectively fitted in the grooves 23 and 24, the anti-separation surface 41b of the claw 41 contacts the wall of the groove 23 of the part 20, and the anti-separation surface of the claw 44 contacts the wall of the groove 24 of the part 20, so that the joining n ember 40 and the part 20 are inseparably joined.

Likewise, the claws 42 and 45 of the joining member 40 are pushed into the space 32 through the opening 31 of the part 30, and the claws 42 and 45 are respectively fitted in the grooves 33 and 34 of the part 30, so that the joining member 40 and the part 30 are inseparably joined.

As a result, the operator obtains the three-dimensional object 10 structured as illustrated in FIGS. 1 and 2.

Next how to separate the parts 20 and 30 of the three-dimensional object 10 is described.

To detach the parts 20 and 30 of the three-dimensional object 10 from each other, the operator breaks the joining member 40 by pulling with a certain or greater strength one of the parts 20 and 30 from the other in a direction in which the part 20 or 30 is drawn apart from the other, or by rotating with a certain or greater strength one of the parts 20 and 30 relative to the other about the center axis of the part 20 or 30.

The operator may transport the separated parts to a storage and keep the parts there, or may transport the separated parts to a new location and recombine the parts to build and install the built three-dimensional object 10 at the new location.

As described so far, the three-dimensional object 10 can be divided into the parts 20 and 30 and thus may be easier to handle than the known art during transportation and installation even if the object is large in size.

The joining member 40 joining the parts 20 and 30 of three-dimensional object 10 may need to be broken to detach the parts 20 and 30 from each other. In that case, reuse of the joining member 40 is not possible. On the other hand, the joined parts 20 and 30 may be easily separated by simply breaking the joining member 40.

After the joining member 40 is broken to separate the parts 20 and 30 of the three-dimensional object 10, a new joining member 40 may be used to rejoin the parts 20 and 30.

At least one of the joining member 40 and the parts 20 and 30 may be manufactured by other means instead of 3D printing using the 3D printer 100, for example, FDM (Fused Deposition Modeling), powder forming, or 3D photolithography (spot irradiation of a liquid-filled container with laser light).

The joining member 40 may have any other shape but the shape described in this embodiment in so far as the parts 20 and 30 are thereby successfully joined.

The three-dimensional object 10 has two parts: parts 20 and 30; however, it may have three or more parts.

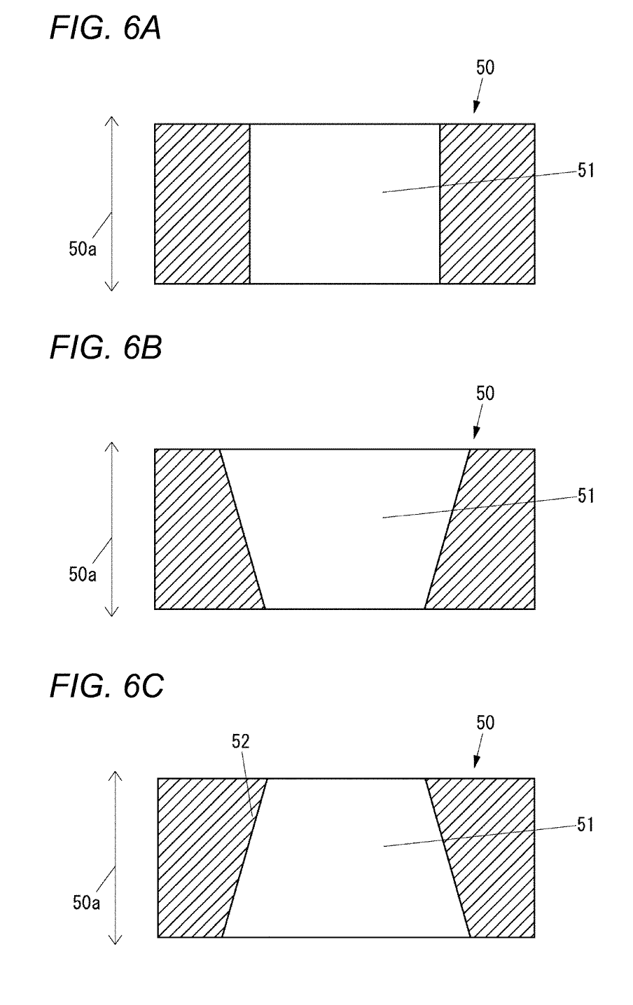

FIG. 6A is a front, cross-sectional view of an example of parts of the three-dimensional object 10. FIG. 6B is a front, cross-sectional view of an example of parts of the three-dimensional object 10 that differs from the example of FIG. 6A. FIG. 6C is a front, cross-sectional view of an example of parts of the three-dimensional object 10 that differs from the examples of FIGS. 6A and 6B.

A part 50 illustrated in FIG. 6 is situated so that a direction indicated with arrow 50a is along the vertical direction, and other parts are disposed on the vertically upper and lower sides of the part 50.

The part 50 having a cavity 51 inside requires less materials, achieving light weight and reduction in material cost.

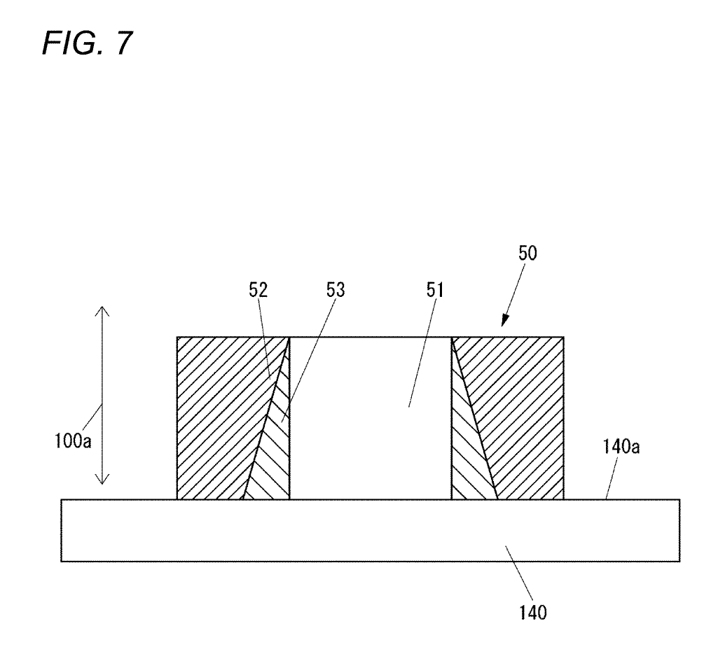

FIG. 7 is a drawing of the part 50 illustrated in FIG. 6C during the manufacturing process.

In a case where the part 50 manufactured by 3D printing using the 3D printer 100 (see FIG. 4) has an overhang portion 52 as illustrated in FIG. 6C, a support portion 53 is necessary that is formed on the vertically lower side of the overhang portion 52 to support the overhang portion 52, as illustrated in FIG. 7.

Therefore, the part 50 with no overhang portion, as illustrated in FIGS. 6A and 6B, can reduce usage of the support ink, achieving reduction in material cost. To form the wall surface of the cavil 51 with high accuracy without using the support ink, an inclined surface, like the one illustrated in FIG. 6B, may be more preferable for the wall surface of the cavity 51 than a vertically straight surface, like the one illustrated in FIG. 6A.

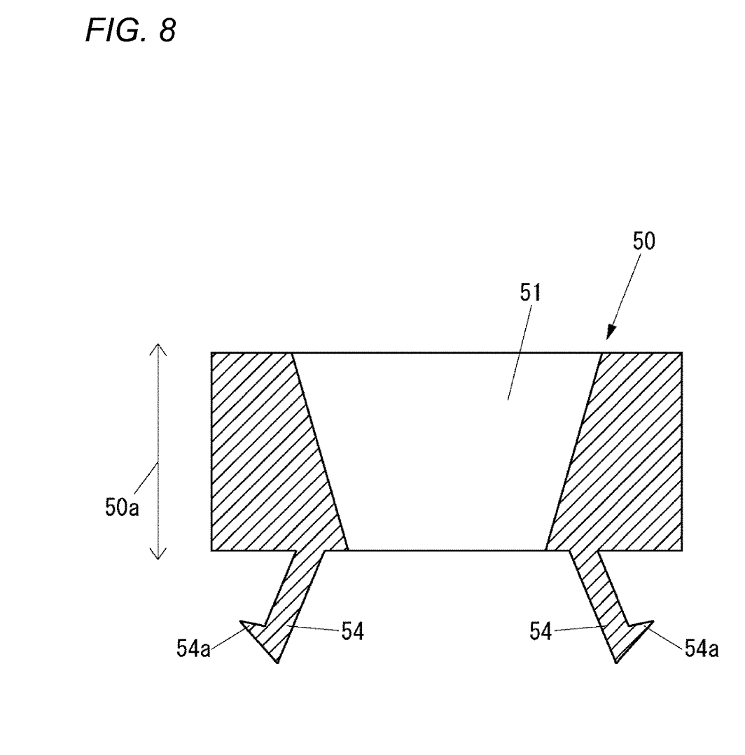

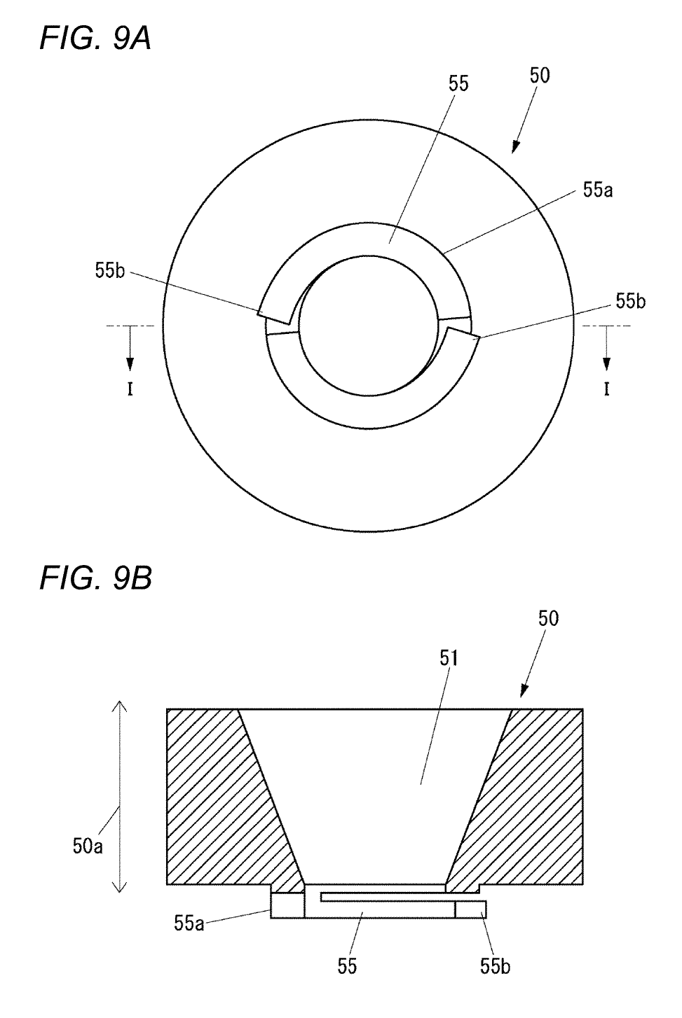

FIG. 8 is a front, cross-sectional view of an example of parts of the three-dimensional object 10 that differs from the examples of FIGS. 6. FIG. 9A is a bottom view of an example of parts of the three-dimensional object 10 that differs from the examples of FIGS. 6 and 8. FIG. 9B is an I-I cross-sectional view of FIG. 9A.

The part 50 illustrated in FIG. 6B has a greater wall thickness toward its vertically lower side. In the part 50 thus shaped, joining members 54 and 55 that join the part 50 with other parts may be more suitably formed on the vertically lower side, as illustrated in FIGS. 8 and 9.

The joining member 54 illustrated in FIG. 8 has claws 54a. By moving the part 50 toward another part on the vertically lower side, the claws 54a are fitted in recesses formed in the vertically lower part.

The joining member 55 illustrated in FIG. 9 has a threaded section 55a and a claw 55b. By rotating the part 50 about a vertically extending axis relative to another part on the vertically lower side, the threaded section 55a is engaged with the vertically lower part, and the claw 55b of the joining member 55 is fitted in a recess formed in the vertically lower part.

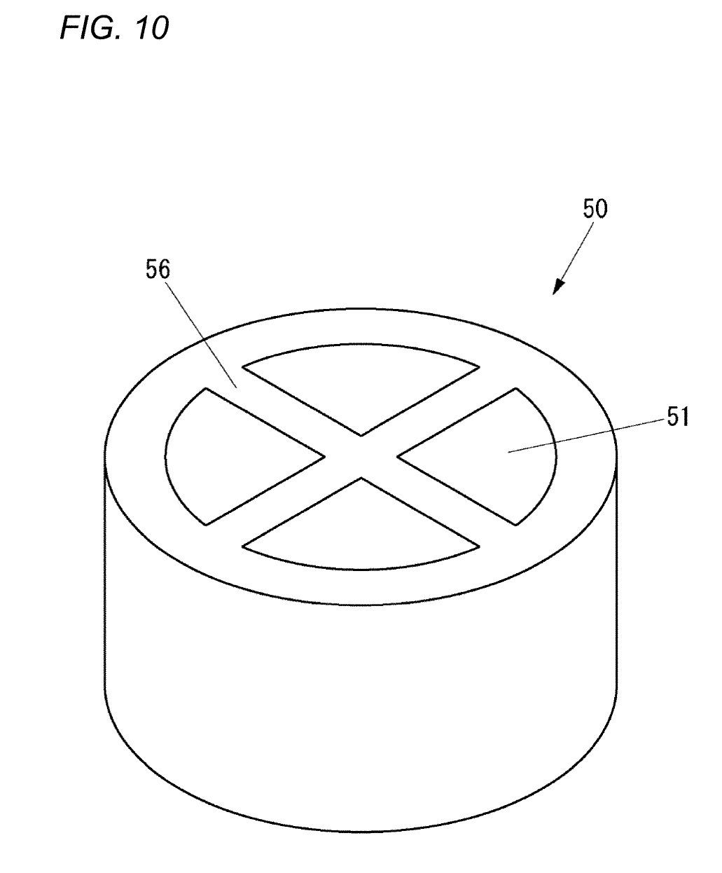

FIG. 10 is a perspective view of an example of parts of the three-dimensional object 10 that differs from the examples of FIGS. 6, 8, and 9.

In contrast to the shapes illustrated in FIGS. 6, the part 50 further has a reinforcing structure 56 in the cavity 51, as illustrated in FIG. 10. The part 50 illustrated in FIG. 10 may be improved in strength as compared with the part 50 illustrated in FIG. 6. In the part 50, the cavity 51 is divided by the reinforcing structure 56 into smaller cavities. In a case where the part 50 is formed in no-overhang shapes like the ones illustrated in FIGS. 6A and 6B, usage of the support ink may be reduced. The wall surfaces of the cavities formed by having the cavity 51 divided by the reinforcing structure 56 may be inclined surfaces like the one illustrated in FIG. 6B. Such an inclined surface may be formed with higher accuracy than a vertically straight surface like the one illustrated in FIG. 6A.

### Second Embodiment

The structure of a three-dimensional object according to a second embodiment is hereinafter described.

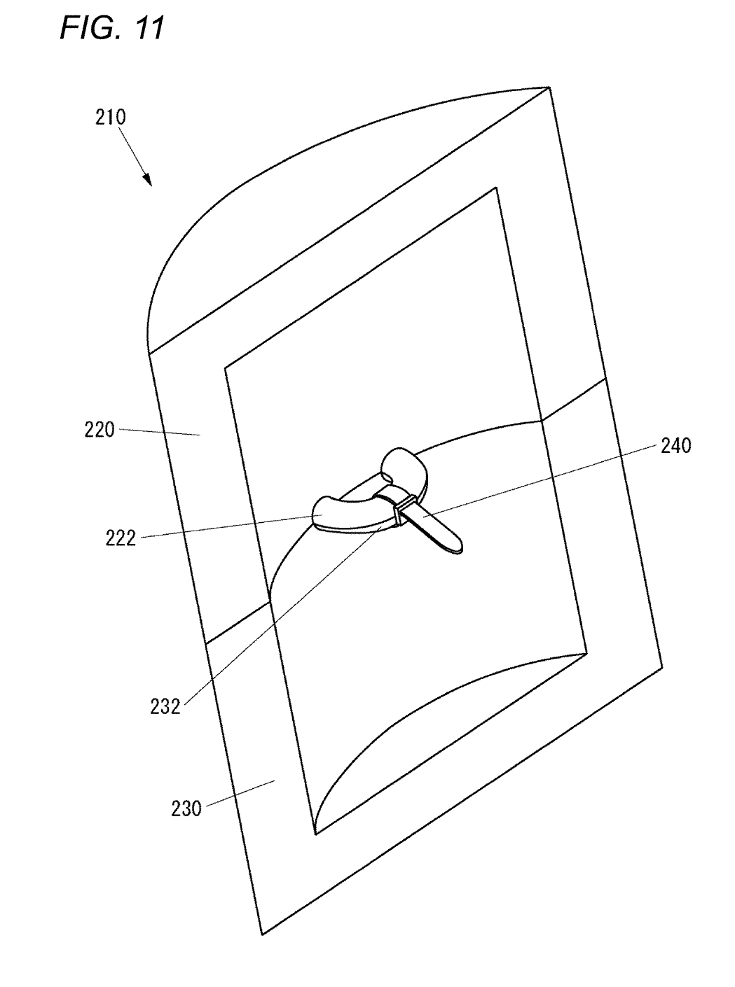

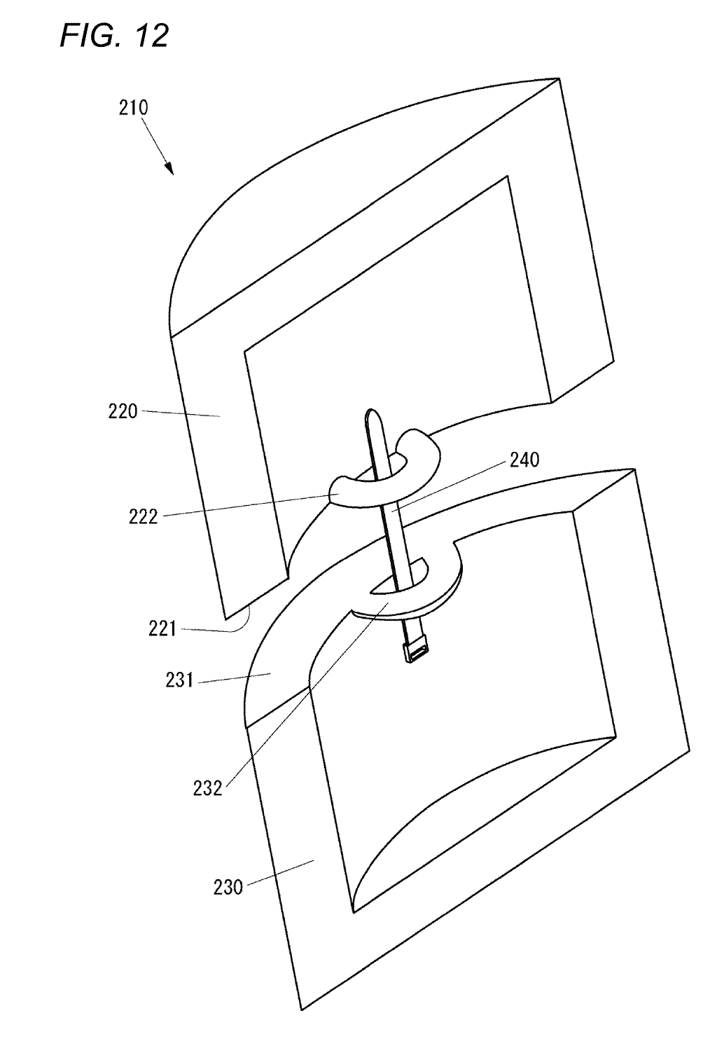

FIG. 11 is a perspective view in part of a three-dimensional object 210 according to this embodiment. FIG. 12 is an exploded perspective view in part of the three-dimensional object 210.

As illustrated in FIGS. 11 and 12, the three-dimensional object 210 includes a part 220, a part 230, and a joining member 240 that joins the parts 220 and 230. The joining member 240 is independent from the parts 220 and 230.

The part 220 has a contact surface 221 that makes contact with the part 230. The part 220 has, near the contact surface 221, a bindable section 222 to be tied with the joining member 240.

The part 230 has a contact surface 231 that makes contact with the part 220. The part 230 has, near the contact surface 231, a bindable section 232 to be tied with the joining member 240.

The bindable section 222 of the part 220 and the bindable section 232 of the part 230 are tied together with the joining member 240 to join the parts 220 and 230. An example of the joining member 240 is a cable tie. The joining member 240 may be cut and broken at the time of separating the joined parts 220 and 230.

A method for manufacturing the three-dimensional object 210 is hereinafter described.

An operator brings the contact surfaces 221 and 231 of the parts 220 and 230 into contact with each other, and then ties the bindable sections 222 and 232 of the parts 220 and 230 together using the joining member 240 to join the parts 220 and 230. As a result, the three-dimensional object 210 illustrated in FIG. 11 is obtained.

Next how to separate the parts 220 and 230 of the three-dimensional object 210 is described.

The operator unties the bindable sections 222 and 232 of the parts 220 and 230 tied with the joining member 240 to detach the parts 220 and 230 from each other. In a case where the joining member 240 is a member that needs to be broken to untie the bindable sections 222 and 232 of the parts 220 and 230, the operator may break the joining member 240 by cutting to detach the parts 220 and 230 from each other.

The operator may transport the separated parts to a storage and keep the parts there, or may transport the separated parts to a new location and recombine the parts to build and install the built three-dimensional object 210 at the new location.

As described so far, the three-dimensional object 210 can be divided into the parts 220 and 230 and thus may be easier to handle than the known art during transportation and installation even if the object is large in size.

The three-dimensional object 210 is structured to join the parts 220 and 230 by having the bindable sections 222 and 232 of the parts 220 and 230 tied together with the joining member 240. This may facilitate the process to join the parts 220 and 230.

The joining member 240 joining the parts 220 and 230 of the three-dimensional object 210 may need to be broken to untie the bindable sections 222 and 232 of the parts 220 and 230 in order to separate the parts 220 and 230. In that case, reuse of the joining member 240 is not possible. On the other hand, the joined parts 220 and 230 may be easily separated by simply breaking the joining member 240.

Even if the joining member 240 joining the parts 220 and 230 in the three-dimensional object 210 needs to be broken to untie the bindable sections 222 and 232 of the parts 220 and 230, the joining member 240 broken to separate the parts 220 and 230 may be replaced with a new joining member 240 to rejoin the parts 220 and 230.

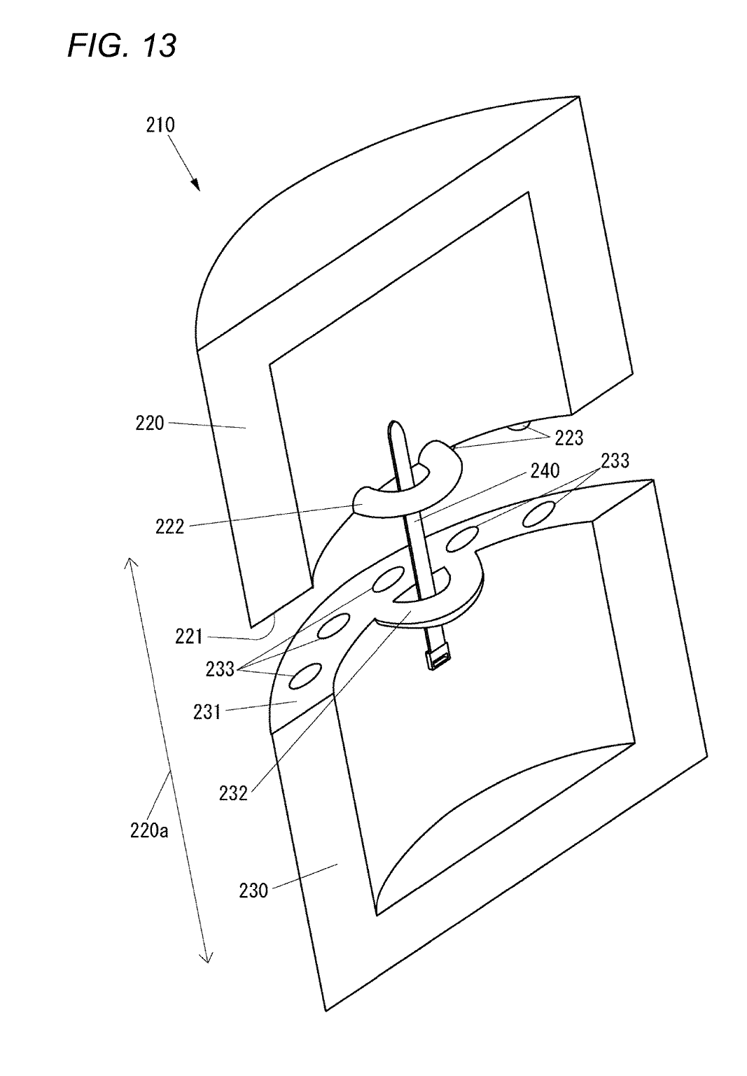

FIG. 13 is an exploded perspective view in part of the three-dimensional object 210 that differs from the example of FIG. 12.

As illustrated in FIG. 13, the parts 220 and 230 may have mating sections 223 and 233 to be mated with each other in a direction indicated with arrow 220a. in which these parts are joined with the joining member 240. The part 220 has plural mating sections 223 on the contact surface 221. The mating sections 223 are, for example, semi-circular projections. The part 230 has plural mating sections 233 on the contact surface 231. The mating sections 233 are, for example, semi-circular grooves.

In the three-dimensional object 210 structured as illustrated in FIG. 13, the mating sections 223 and 233 of the parts 220 and 230 are mated with each other to prevent displacement of these two parts in a direction orthogonal to the direction indicated with arrow 220a. Thus, the parts 220 and 230 may be further reliably combined.

The joining member 240 and the parts 220 and 230 of the three-dimensional object 210 may be manufactured by 3D printing using the 3D printer 100 (see FIG. 4) as with the first embodiment, or may be manufactured by any other means but the 3D printing, for example, FDM (Fused Deposition Modeling), powder forming, or 3D photolithography (spot irradiation of a liquid-filled container with laser light).

The joining member 240 may have any other shape but the shape described in this embodiment in so far as the parts 220 and 230 are thereby successfully joined.

The three-dimensional object 210 has two parts: parts 220 and 230 however, it may have three or more parts.

### Third Embodiment

The structure of a three-dimensional object according to a third embodiment of the present disclosure is hereinafter described.

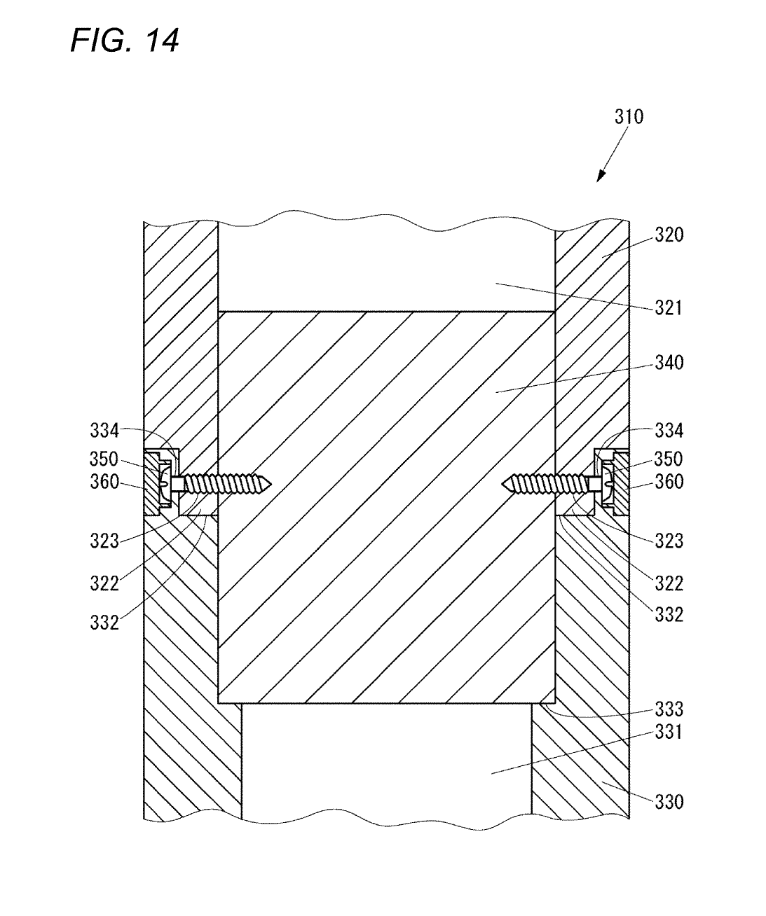

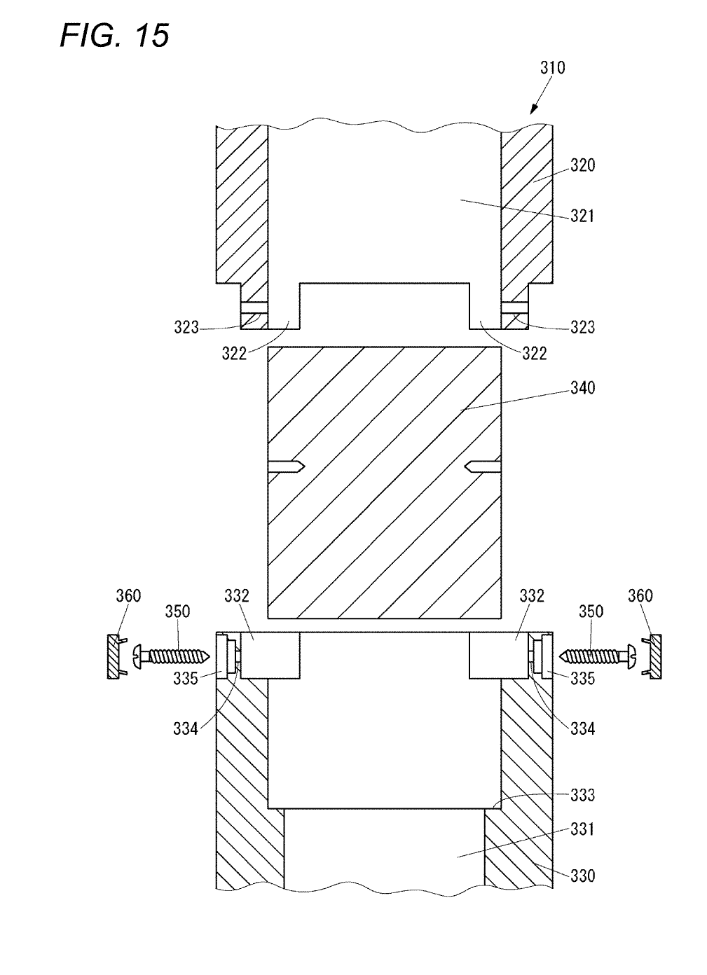

FIG. 14 is a front, cross-sectional view in part of a three-dimensional object 310 according to this embodiment. FIG. 15 is an exploded front, cross-sectional view in part of the three-dimensional object 310.

As illustrated in FIGS. 14 and 15, the three-dimensional object 310 has parts 320 and 330, a reinforcing member 340 that reinforces joints of the parts 320 and 330, screws 350 used to join the reinforcing member 340 and the parts 320 and 330, and screw-concealing caps 360 for concealing the screws 350. The screw 350 is a joining member that joins the parts 320 and 330.

The part 320 has a substantially columnar shape with a cavity 321 formed inside. The part 320 has a mating section 322 to be mated with the part 330. The part 320 has holes 323 for the screws 350 to be inserted.

The part 330 has a substantially columnar shape with a cavity 331 formed inside. The part 330 has a mating section 332 to be mated with the mating section 322 of the part 320. The part 330 further has a mating section 333 to be mated with the reinforcing member 340. The part 330 has holes 334 and holes 335. The screws 350 are inserted in the holes 334, and the screw-concealing caps 360 are inserted in the holes 335.

The reinforcing member 340 has a columnar shape and is contained in the cavity 321 of the part 320 and the cavity 331 of the part 330.

A method for manufacturing the three-dimensional object 310 is hereinafter described.

An operator mates the mating section 333 of the part 330 with the reinforcing member 340, and then mates the mating section 322 of the part 320 and the mating section 332 of the part 330 with each other. Then, the operator inserts the screws 350 in the holes 334 of the part 330 and into the holes 323 of the part 320, so that the parts 320 and 330 and the reinforcing member 340 are joined with the screws 350. Finally, the operator inserts the screw-concealing caps 360 into the holes 335 of the part 330. As a result, the three-dimensional object 310 illustrated in FIG. 14 is obtained.

Next how to separate the parts 320 and 330 of the three-dimensional object 310 is described.

The operator removes the screw-concealing caps 360 and then removes the screws 350 to separate the object 310 into the part 320, part 330, and reinforcing member 340.

The operator may transport the separated parts and reinforcing member 340 to a storage and keep these parts and member there, or may transport the separated parts and reinforcing member 340 to a new location and recombine them to build and install the built three-dimensional object 310 at the new location.

As described so far, the three-dimensional object 310 can be divided into the parts 320 and 330 and thus may be easier to handle than the known art during transportation and installation even if the object is large in size.

In the three-dimensional object 310 not equipped with the reinforcing member 340, the joints of the parts 320 and 330 may be mostly poor in strength and thus may be easily breakable. In the three-dimensional object further 310 provided with the reinforcing member 340 that reinforces the joints of the parts 320 and 330, on the other hand, breakage of the parts 320 and 330 at their joints may be unlikely to occur.

The parts 320 and 330, reinforcing member 340, and screw-concealing caps 360 of the three-dimensional object 310 may be manufactured by 3D printing using the 3D printer 100 (see FIG. 4) as with the first embodiment, or may be manufactured by any other means but the 3D printing, for example, FDM (Fused Deposition Modeling), powder forming, or 3D photolithography (spot irradiation of a liquid-filled container with laser light).

The three-dimensional object 310 has the screws 350; joining member independent from the reinforcing member 340. The joining member, however, may be any means or structured otherwise in so far as the parts 320 and 330 are thereby successfully joined. For example, in the three-dimensional object 310, the reinforcing member may constitute at least part of the joining member.

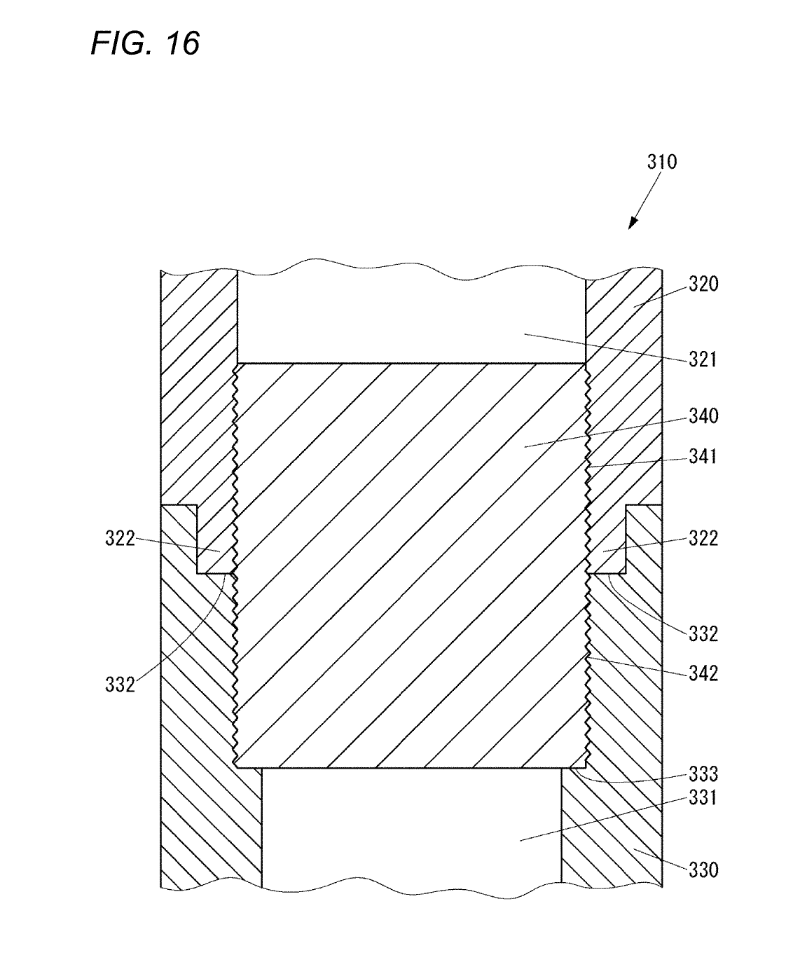

FIG. 16 is a front, cross-sectional view of the three-dimensional object 310 that differs from the example of FIG. 14.

In the three-dimensional object 310 illustrated in FIG. 16, the reinforcing member 340 has a threaded section 341 that connects the part 320 and the reinforcing member 340, and a threaded section 342 that connects the part 330 and the reinforcing member 340. The reinforcing member 340 illustrated in FIG. 16 also serves to join the parts. By thus having the reinforcing member 340 serve as the joining member as well, the three-dimensional object 310 may be structurally simplified.

While the reinforcing member 340 has the threaded sections 341 and 342 in the example of FIG. 16, the reinforcing member 340 may be structured otherwise to become at least part of the joining member. For example, the reinforcing member 340 may be an elastic member. When the elastic reinforcing member 340 is pressed into the cavity 321 of the part 320 and the cavity 331 of the part 330, the parts 320 and 330 may be joined to each other with the reinforcing member 340. The reinforcing member 340 can acquire elasticity by selecting its material from elastic materials such as synthetic rubbers, urethane rubbers, silicon resins, and cork, or the reinforcing member 340 may be a structurally elastic member such as an annularly-bendable spring made of a metallic plate, for example, SUS304. In a case where the elastic reinforcing member 340 is elastic and pressed into the cavities 321 and 331 of the parts 320 and. 330, the cavities 321 and 331 are not necessarily columnar but may have any optional shape suitably selected.

The three-dimensional object 310 has two parts: parts 320 and 330; however, it may have three or more parts.

### Fourth Embodiment

The structure of a three-dimensional object according to a fourth embodiment of the present disclosure is hereinafter described.

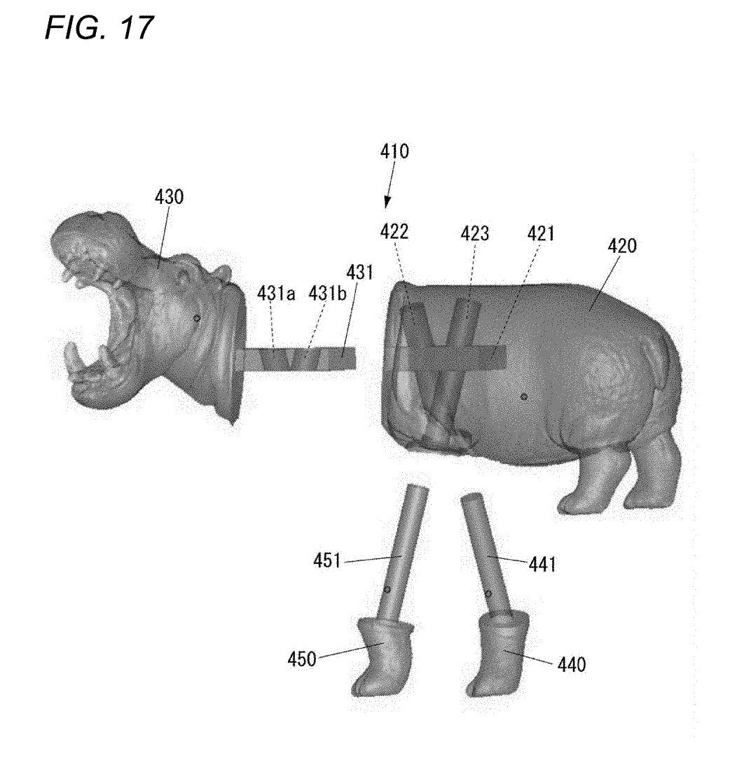

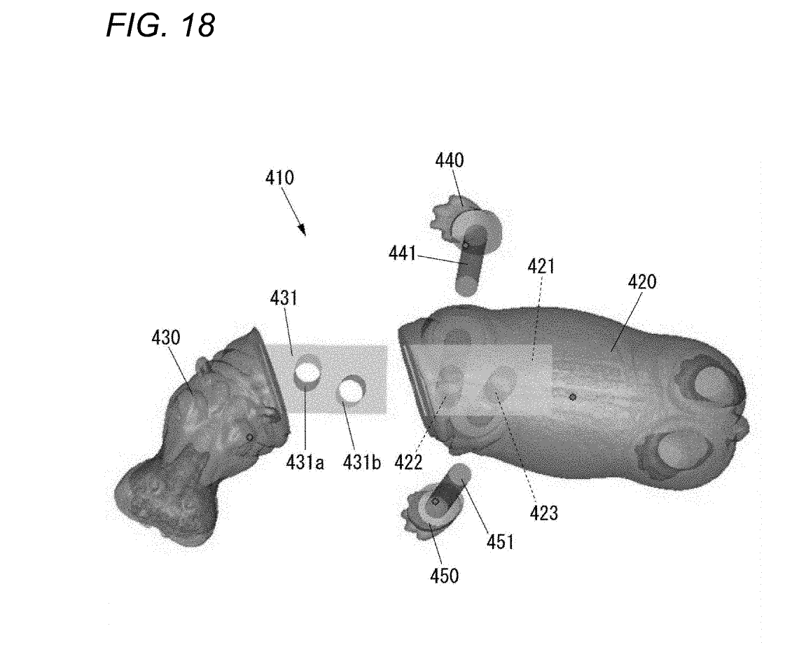

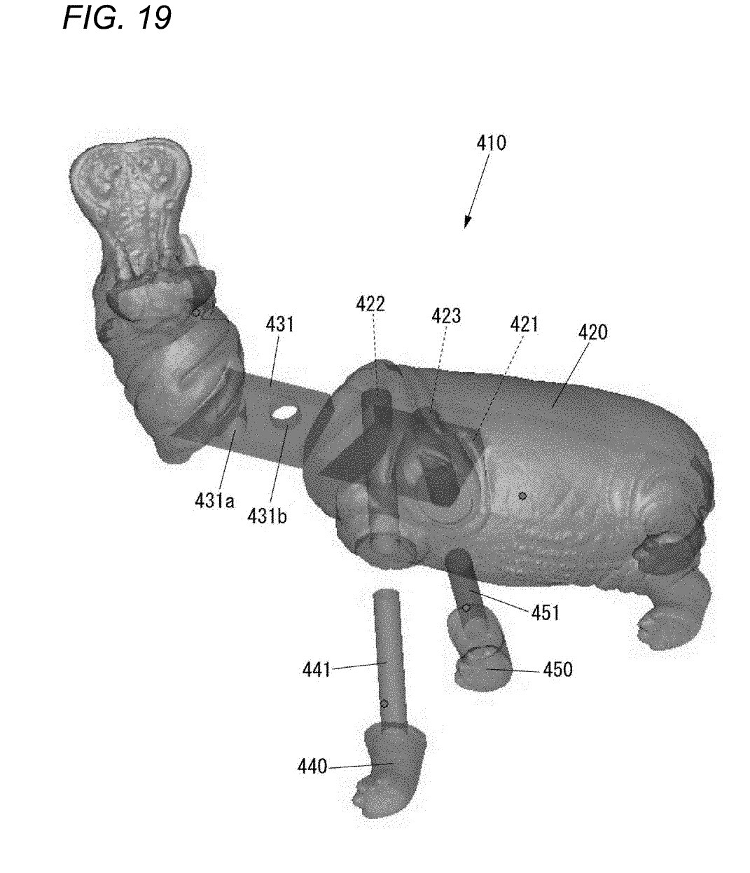

FIG. 17 is an exploded side view of a three-dimensional object 410 according to this embodiment. FIG. 18 is an exploded plan view of the three-dimensional object 410. FIG. 19 is an exploded perspective view of the three-dimensional object 410 when observed from the bottom side of the object.

As illustrated in FIGS. 17 to 19, the three-dimensional object 410 is a life-sized model of hippopotamus. The three-dimensional object 410 has a part 420 constituting the body and two hind legs, a part 430 constituting the head, a part 440 constituting the right foreleg, and a part 450 constituting the left foreleg.

The part 420 has a cuboidal insert-receiving section 421 that receives an insert 431 of the part 430, a columnar insert-receiving section 422 that receives an insert 441 of the part 440, and a columnar insert-receiving section 423 that receives an insert 451 of the part 450. These sections of the part 420 constitute the insert-receiving parts of this disclosure. The inserts 431, 441, and 451 will be described later.

The part 430 has the cuboidal insert 431 to be inserted in the insert-receiving section 421 of the part 420. This insert of the part 430 constitutes the insertion parts of this disclosure. The insert 431 has through holes 431a and 431b. These through holes serve as insert-receiving sections that receive corresponding inserts. With the insert 431 of the part 430, insert 441 of the part 440, and insert 451 of the part 450 being respectively inserted in corresponding ones of the insert-receiving sections 421, 422, and 423, the insert 441 of the part 440 is inserted in the through hole 431a, and the insert 451 of the part 450 is inserted in the through hole 431b.

The part 440 has a columnar insert 441 to be inserted in the insert-receiving section 422 of the part 420. This insert of the part 440 constitutes the insertion parts of this disclosure.

The part 450 has a columnar insert 451 to be inserted in the insert-receiving section 423 of the part 420. This insert of the part 450 constitutes the insertion parts of this disclosure.

A method for manufacturing the three-dimensional object 410 is hereinafter described.

An operator inserts the insert 431 of the part 430 in the insert-receiving section 421 of the part 420, and then inserts a respective one of the insert 441 of the part 440 and the insert 451 of the part 450 in the insert-receiving section 422, 423 of the part 420. The insert 441 of the part 440 and the insert 451 of the part 450 thus respectively inserted in the insert-receiving sections 422 and 423 of the part 420 are then inserted in the through holes 431a and 431b of the insert 431 of the part 430.

In a case where the three-dimensional object 410 is located on a floor, for example, the parts 440 and 450 may bear at least part of weights of the parts 420 and 430 conveyed through the vertically upper part 420. Therefore, the parts 440 and 450 of the three-dimensional object 410 on the floor may be prevented from moving away from the part 420 in directions in which these parts possibly fall out of the part 420. By thus preventing the parts 440 and 450 from moving away from the part 420 in directions in which these parts possibly fall out of the part 420, the inserts 441 and 451 of the parts 440 and 450 make contact with the through holes 431a and 431b of the insert 431. This may prevent movement of the part 430 away from the part 420 in directions in which the part 430 possibly fall out of the part 420.

Next how to separate the parts 420 to 450 of the three-dimensional object 410 is described.

The operator pulls the insert 441 of the part 440 and the insert 451 of the part 450 out of the insert-receiving sections 422 and 423 of the part 420 and out of the through holes 431a and 431b of the insert 431 of the part 430. Then, the insert 431 of the part 430 can be pulled out of the insert-receiving section 421 of the part 420.

The operator pulls the insert 431 of the part 430 out of the insert-receiving section 421 of the part 420.

In this manner, the operator divides the object into the parts 420 to 450.

The operator may transport the separated parts to a storage and keep the parts there, or may transport the separated parts to a new location and recombine the parts to build and install the built three-dimensional object 410 at the new location.

As described so far, the three-dimensional object 410 can be divided into the parts 420 to 450 and thus may be easier to handle than the known art during transportation and installation even if the object is large in size.

In the three-dimensional object 410, the parts 430, 440, and 450 are engaged with one another to be immovably joined to the part 420. Therefore, a part-joining member independent from the respective parts is less required of such a three-dimensional object. This may facilitate the process to separate the parts.

The parts 420 to 450 of the three-dimensional object 410 may be manufactured by 3D printing using the 3D printer 100 (see FIG. 4) as with the first embodiment, or tray be manufactured by any other means but the 3D printing, for example, FDM (Fused Deposition Modeling), powder forming, or 3D photolithography (spot irradiation of a liquid-filled container with laser light).

What is claimed is:

1. A three-dimensional object comprising:
a plurality of parts; and
a joining member that joins the plurality of parts,
the joining member being independent from the plurality of parts and breakable at the time of separating the plurality of parts that are joined.

2. A three-dimensional object comprising:
a plurality of parts; and
a joining member that joins the plurality of parts,
the plurality of parts comprising bindable sections to be tied together with the joining member,
the joining member being independent from the plurality of parts and serving to bind the bindable sections of the plurality of parts to join the plurality of parts.

3. The three-dimensional object according to claim 2, wherein one and another one of the plurality of parts joined with the joining member comprise mating sections to be mated with each other in a direction in which the plurality of parts are joined with the joining member.

4. A three-dimensional object comprising:
a plurality of parts;
a joining member that joins the plurality of parts, and
a reinforcing member that reinforces joints of the plurality of parts,
the reinforcing member being independent from the plurality of parts and containable inside of the plurality of parts.

5. The three-dimensional object according to claim 4, wherein the reinforcing member constitutes at least part of the joining member.

6. A three-dimensional object comprising a plurality of parts,
the plurality of parts comprising a plurality of insertion parts that include inserts to be inserted,
the plurality of parts further comprising insert-receiving parts having a plurality of receiving sections that receive the inserts to be inserted,
the insert of at least one of the plurality of insertion parts comprising a receiving section,
with the inserts of the plurality of insertion parts being inserted in corresponding ones of the receivers of the insert-receiving parts, the receiving section receiving the insert to be inserted of at least another one of the plurality of insertion parts.
